(19) United States
(12) Patent Application Publication
(10) Pub. No.: US 2005/0080284 A1
(43) Pub. Date: Apr. 14, 2005

(54) Cyclic silicon compounds

(75) Inventors: Robert Kuimelis, Palo Alto, CA (US); Glenn H. McGall, Palo Alto, CA (US)

Correspondence Address: AFFYMETRIX, INC;ATTN: CHIEF IP COUNSEL, LEGAL DEPT., 3380 CENTRAL EXPRESSWAY, SANTA CLARA, CA, 95051, US

(73) Assignee: Affymetrix, Inc., Santa Clara, CA (US)

(21) Appl. No.: 10/674,711

(22) Filed: Sep. 29, 2003

(51) Int. Cl. C07F 7/02; C07F 7/10; C07F 7/21

(52) U.S. Cl. 556/407; 556/408

(57) ABSTRACT

The present invention provides cyclic silane based compounds. In accordance with one aspect of the present invention, it has been discovered that certain linear silane compounds can cyclize under some conditions. In one aspect of the present invention, cyclic silanes having the following formula are presented: 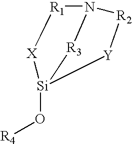
In another aspect of the present invention, cyclic silanes having the following formula are presented:

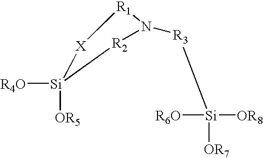

### FIELD OF THE INVENTION

The present invention relates to silicon based compounds. More particularly, the present invention relates to cyclic silicon compounds.

### BACKGROUND OF THE INVENTION

Silylating agents have been developed in the art which react with and coat surfaces, such as silica surfaces. For example, silylating agents for use in modifying silica used in high performance chromatography packings have been developed. Monofunctional silylating agents have been used to form monolayer surface coatings, while di- and tri-functional silylating agents have been used to form polymerized coatings on silica surfaces. Many silylating agents, however, produce coatings with undesirable properties including instability to hydrolysis and the inadequate ability to mask the silica surface which may contain residual acidic silanols.

Silylating agents have been developed for the silylation of solid substrates, such as glass substrates, that include functional groups that may be derivatized by further covalent reaction. The silylating agents have been immobilized on the surface of substrates, such as glass, and used to prepare high density immobilized oligonucleotide probe arrays. For example, N-(3-(triethoxysilyl)-propyl)-4-hydroxybutyramide (PCR Inc., Gainesville, Fla. and Gelest, Tullytown, Pa.) has been used to silylate a glass substrate prior to photochemical synthesis of arrays of oligonucleotides on the substrate, as described in McGall et al., J. Am. Chem. Soc., 119:5081-5090 (1997), the disclosure of which is incorporated herein by reference.

Hydroxyalkylsilyl compounds that have been used to prepare hydroxyalkylated substances, such as glass substrates. N,N-bis(hydroxyethyl) aminopropyl-triethoxysilane has been used to treat glass substrates to permit the synthesis of high-density oligonucleotide arrays. McGall et al., Proc. Natl. Acad. Sci., 93:13555-13560 (1996); and Pease et al., Proc. Natl. Acad. Sci., 91:5022-5026 (1994), the disclosures of which are incorporated herein. Acetoxypropyl-triethoxysilane has been used to treat glass substrates to prepare them for oligonucleotide array synthesis, as described in PCT WO 97/39151, the disclosure of which is incorporated herein. 3-Glycidoxy propyltrimethoxysilane has been used to treat a glass support to provide a linker for the synthesis of oligonucleotides. EP Patent Application No. 89 120696.3.

Methods have been developed in the art for stabilizing surface bonded silicon compounds. The use of sterically hindered silylating agents is described in Kirkland et al., Anal. Chem. 61: 2-11 (1989); and Schneider et al., Synthesis, 1027-1031 (1990).

### SUMMARY OF THE INVENTION

According to one aspect of the present invention, cyclic silanes are presented having the formula 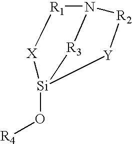
wherein R₁, R₂ R₃ and R₄ are independently alkyl, functionalized alkyl, aryl or alkoxy and X, Y and Z are independently a bond, O, S, NR₅, wherein R₅ is H or alkyl.

In another aspect of the present invention, cyclic silanes are presented having the formula 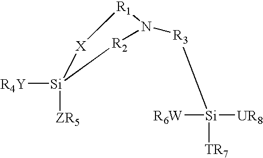
wherein R₁, R₂, R₃, R_{4,} R₅, R₆, R₇ and R₈ are independently alkyl, functionalized alkyl, aryl or alkoxy and X, Y, Z, W, T and U are independently a bond, O, S, NR₅, wherein R₅ is H or alkyl.

Other cyclic silanes are also disclosed in accordance with the present invention. Cyclic silanes of N,N-bis(2-hydroxyethyl)-N-(3-triethoxysilylpropyl)amine and N-(2-hydroxyethyl)-N,N-bis(3-trimethoxysilylpropyl)amine are particularly preferred embodiements of one aspect of the present invention.

Compositions of matter comprising a substantially pure cyclic silane are also disclosed.

### BRIEF DESCRIPTION OF THE DRAWINGS

FIG. 1 shows a 13C NMR spectrum of Bis silane.

FIG. 2 shows a 1H NMR spectrum of Bis silane.

FIG. 3 shows a 13C NMR spectrum of Bis-B silane.

FIG. 4 shows a 1H NMR spectrum of Bis-B silane

FIG. 5 shows a GC/MS ion chromatogram of Bis silane.

FIG. 6 shows a GC/MS ion chromatogram of Bis B silane

FIG. 7 shows the cyclic structure of Bis and Bis B silane.

### DETAILED DESCRIPTION OF THE INVENTION

The present invention has many preferred embodiments and relies on many patents, applications and other references for details known to those of the art. Therefore, when a patent, application, or other reference is cited or repeated below, it should be understood that it is incorporated by reference in its entirety for all purposes as well as for the proposition that is recited.

As used in this application, the singular form “a,” “an,” and “the” include plural references unless the context clearly dictates otherwise. For example, the term “an agent” includes a plurality of agents, including mixtures thereof.

An individual is not limited to a human being but may also be other organisms including but not limited to mammals, plants, bacteria, or cells derived from any of the above.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The practice of the present invention may employ, unless otherwise indicated, conventional techniques and descriptions of organic chemistry, polymer technology, molecular biology (including recombinant techniques), cell biology, biochemistry, and immunology, which are within the skill of the art. Such conventional techniques include polymer array synthesis, hybridization, ligation, and detection of hybridization using a label. Specific illustrations of suitable techniques can be had by reference to the example hereinbelow. However, other equivalent conventional procedures can, of course, also be used. Such conventional techniques and descriptions can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), Stryer, Biochemistry, 4^{th} Ed., 1995, W. H. Freeman, Gait, “Oligonucleotide Synthesis: A Practical Approach” 1984, IRL Press, London, all of which are herein incorporated in their entirety by reference for all purposes.

The practice of the present invention may also employ conventional computational biology methods, software or systems. Basic computational biology methods are described in, e.g., Setubal and Meidanis, et al., 1997, Introduction to Computational Molecular Biology, PWS Publishing Company, Boston; Human Genome Mapping Project Resource Centre (Cambridge), 1998, Guide to Human Genome Computing, 2nd Edition, Martin J. Biship (Editor), Academic Press, San Diego; Salzberg, Searles, Kasif, (Editors), 1998, Computational Methods in Molecular Biology, Elsevier, Amsterdam;

The present invention can employ solid substrates, including arrays in some preferred embodiments. Methods and techniques applicable to polymer (including protein) array synthesis have been described in U.S. Ser. No. 09/536,841, WO 00/58516, U.S. Pat. Nos. 5,143,854, 5,242,974, 5,252,743, 5,324,633, 5,384,261, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, and 6,136,269, in PCT Applications Nos. PCT/US99/00730 (International Publication Number WO 99/36760) and PCT/US 01/04285, and in U.S. patent applications Ser. Nos. 09/501,099 and 09/122,216 which are all incorporated herein by reference in their entirety for all purposes.

Patents that describe synthesis techniques in specific embodiments include U.S. Pat. Nos. 5,412,087, 6,147,205, 6,262,216, 6,310,189, 5,889,165, and 5,959,098. Nucleic acid arrays are described in many of the above patents, but the same techniques are applied to polypeptide arrays.

The present invention also contemplates many uses for polymers attached to solid substrates. These uses include gene expression monitoring, profiling, library screening, genotyping, and diagnostics. Gene expression monitoring, and profiling methods can be shown in U.S. Pat. Nos. 5,800,992, 6,013,449, 6,020,135, 6,033,860, 6,040,138, 6,177,248 and 6,309,822. Genotyping and uses therefor are shown in U.S. Ser. No. 10/013,598, and U.S. Pat. Nos. 5,856,092, 6,300,063, 5,858,659, 6,284,460 and 6,333,179. Other uses are embodied in U.S. Pat. Nos. 5,871,928, 5,902,723, 6,045,996, 5,541,061, and 6,197,506.

The present invention also contemplates sample preparation methods in certain preferred embodiments. For example, see the patents in the gene expression, profiling, genotyping and other use patents above, as well as U.S. Ser. No. 09/854,317, Wu and Wallace, Genomics 4, 560 (1989), Landegren et al., Science 241, 1077 (1988), Burg, U.S. Pat. Nos. 5,437,990, 5,215,899, 5,466,586, 4,357,421, Gubler et al., 1985, Biochemica et Biophysica Acta, Displacement Synthesis of Globin Complementary DNA: Evidence for Sequence Amplification, transcription amplification, Kwoh et al., Proc. Natl. Acad. Sci. USA 86, 1173 (1989), Guatelli et al., Proc. Nat. Acad. Sci. USA, 87, 1874 (1990), WO 88/10315, WO 90/06995, and 6,361,947.

The present invention also contemplates detection of hybridization between ligands in certain preferred embodiments. See U.S. Pat. Nos. 5,143,854, 5,578,832; 5,631,734; 5,834,758; 5,936,324; 5,981,956; 6,025,601; 6,141,096; 6,185,030; 6,201,639; 6,218,803; and 6,225,625 and in PCT Application PCT/US99/ 06097 (published as WO99/47964), each of which also is hereby incorporated by reference in its entirety for all purposes.

The present invention may also make use of various computer program products and software for a variety of purposes, such as probe design, management of data, analysis, and instrument operation. See, U.S. Pat. Nos. 5,593,839, 5,795,716, 5,733,729, 5,974,164, 6,066,454, 6,090,555, 6,185,561, 6,188,783, 6,223,127, 6,229,911 and 6,308,170.

The present invention may also provide computer software and computer systems for performing the methods of the invention. Computer software products of the invention typically include computer readable medium having computer-executable instructions for performing the logic steps of the methods of the invention. Suitable computer readable medium include floppy disk, CD-ROM/DVD/DVD-ROM, hard-disk drive, flash memory, ROM/RAM, magnetic tapes and etc. The computer executable instructions may be written in any suitable computer language or combination of several languages.

Additionally, the present invention may have preferred embodiments that include methods for providing genetic information over the internet. See provisional application 60/349,546.

In one aspect of the invention, methods are provided for nucleic acid analysis. In some embodiments, randomly coupled different nucleic acids are used for affinity capture of target nucleic acids. The captured target nucleic acids (on flat substrates, beads, etc.) are detected using spatially addressable oligonucleotides (such as microarrays, beads). In one embodiment, oligonucleotides are synthesized (or presynthesized and attached on) on beads. Each of the beads may contain at least 2, 4, 6, 10, 50, 100, 1000 different oligonucleotides. The oligonucleotides may be designed to hybridize with target nucleic acids to select specifc sequences. A nucleic acid sample is hybridized with the beads. The beads may be washed to reduce nonspecific bindings. The captured nucleic acids (bound nucleic acids) may be eluted, for example, by more stringent hybridization conditions. The elucted nucleic acids may be hybridized to a microarray for detection.

The different oligonucleotides on beads may be synthesized by combinatorial synthesis.

In some embodiments, the oligonucleotides on the beads are designed to select (hybridize) nucleic acids representing certain transcripts (the transcripts themselves or nucleic acids derived from the transcript or their complementary sequences) or nucleic acids representing certain genotyping sites (DNA sequences containing the genotyping sites or nucleic acids derived from such DNA sequences or their complementary sequences).

The selected nucleic acids may be hybridized with microarray chips that detect transcripts or their complements or hybridized with chips that detect SNPs.

In one particularly preferred embodiment, oligonucleotides specific for splicing sites are immobilized (or synthesized on) on beads (each bead may contain different oligonucleotides). The oligonucleotides are used to select splice sites. The oligonucleotides may be, for example, at least 30, 40, 50, 60 bases in length. Nucleic acid sample representing target transcripts may be hybridized with the beads. The target nucleic acids representing the splicing sites may be selected using the beads. The selected target nucleic acids may be hybridized with a microarray designed to interrogate the splicing sites to detect the forms of transcripts (forms of exon combination). The selection step may reduce cross hybridization.

In one embodiment, one set of beads are used to purify (select) one particular junction structure (e.g., exons 1, 2 or exons 2, 3 in a 3 exon gene). The purified nucleic acid from the first set is labeled with one color (e.g., fluorescent label)(C1). A second set is used to purify another set of junction structure (e.g., exons 1, 3 or 3, 4). The second set is labeled with a second color (C2). The resulting labeled nucleic acids are hybridized with a microarray that detects exons 1, 2, 3. The two color signals may be used to analyze relative abundance of alternatively splice transcripts. For example, the ratio C1/C2 may be indicative of relative abundance of different exon combinations.

Definitions

“Alkyl” refers to a straight chain, branched or cyclic chemical group containing only carbon and hydrogen. Alkyl groups include, without limitation, ethyl, propyl, butyl, pentyl, cyclopentyl and 2-methylbutyl. Alkyl groups are unsubstituted or substituted with 1 or more substituents (e.g., halogen, alkoxy, amino, S).

“Aryl” refers to a monovalent, unsaturated aromatic carbocyclic group. Aryl groups include, without limitation, phenyl, naphthyl, anthryl and biphenyl. Aryl groups are unsubstituted or substituted with 1 or more substituents (e.g. halogen, alkoxy, amino).

“Alkoxy” refers to a chemical group of the structure ((CH₂)ₙO(CH₂)m)x , wherein n is an integer ranging from 0 to about 10, and m is an integer ranging from 0 to about 10, wherein both m and n cannot simultaneously be 0 and X is an integer from 1 to 4.

According to one aspect of the present invention, a cyclic silane is presented having the the formula 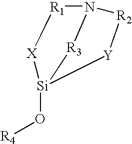
wherein R₁, R₂ R₃ and R₄ are independently alkyl, substituted alkyl, aryl or alkoxy and X and Y are independently a bond, S, NR₅, wherein R₅ is H or alkyl, or O.

Preferably, X and Y are O. R₁, R₂, R₃ and R₄ are preferably C₁ to C₁₀ alkyl. More preferably, R₁, R₂ and R₄ are ethyl and R₃ is propyl. In another preferred embodiment of the present invention, R₁ and R₂ are ethyl and R₄ is methyl.

In still other preferred embodiments, R₁ and R₂ are alkoxy. More preferably, R₁ and R₂ are (CH₂CH₂O)ₙ wherein n is 1-4 and X and Y are bonds.

In a particularly preferred embodiment of the present invention, a cyclic silane having the following formula is presented:

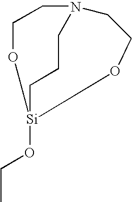

In another aspect of the present invention, a cyclic silane having the following formula is presented: 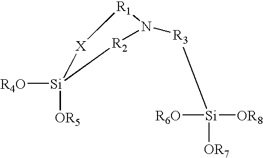
wherein R₁, R₂, R₃, R₅, R₆, R₇ and R₈ are independently alkyl, functionalized alkyl, aryl or alkoxy and X is a bond, S, NR₅, wherein R₅ is H or alkyl, or O.

In accordance with one aspect of the present invention, X is preferably O. R₁, R₂, R₃, R_{4,} R₅, R_{6,} R₇ and R₈ are preferably C₁ to C₁₀ alkyl. More preferably, R₄, R₅, R₆, R₇ and R₈ are methyl and R₁ is ethyl, R₂ is propyl and R₃ is propyl. In another preferred embodiment of the present invention, R₄, R₅, R₆, R₇, and R₈ are ethyl.

In accordance with one aspect of the present invention, R₁ is preferably alkoxy. More preferably, R₁ is (CH₂CH₂O)ₙ wherein n is 1-4 and X is a bond.

In a particularly preferred embodiment of the present invention, a cyclic silane having the following formula is presented:

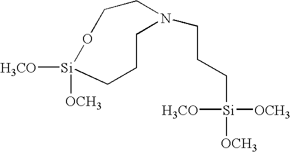

In accordance with one aspect of the present invention, a method of silanating substrates is presented. The method comprises vapor deposition of the silanation reagent onto a substrate. According to the present invention, the substrates are preferably beads, particles, fibers or wafers. Glass wafers are particularly preferred. Vapor deposition of the reagents involves exposure of the substrate to the reagent in a vaccum oven. Prior to the instant invention, it was believed that many silane reagents were not low boiling enough to allow vapor deposition without thermal decomposition of the silane. However, it has been discovered in accordance with one aspect of the present invention that cyclic silanes frequently have lower boiling points than their linear counter parts. The lower boiling points of these compounds makes them amenable to vapor deposition. However, the cyclic silanes of the instant invention may also be used in standard bath deposition or spin coating procedures.

In accordance with another aspect of the present invention, compositions of matter are presented, the compositions comprising substantially pure cyclic silane compounds as disclosed in the instant application. The term “substantially pure” as employed in accordance with the instant invention means a compound which is at least approximately 80% pure. Preferably, the composition of matter comprising a cyclic silane is at least approximately 90% pure. More preferably, the cyclic silane is at least approximately 95% pure. Depending on the temperature and pressure, the substantially pure cyclic silane will exist as a solid, liquid or gas.

In another aspect of the present invention, cyclic silanes are presented having the fomula 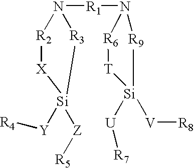
wherein R₁, R₂, R₃, R₄, R₅, R₆, R₇, R₈, and R₉ are alkyl, substituted alkyl, aryl, or alkoxy; and T, U, V, X, Y, and Z are O, S, NHR₁₀, wherein R₁₀ is H, alkyl, substituted alkyl, or aryl.

Preferably, according to the present invention, R₁, R₂, and R₆ are ethyl, R₄, R₅, R₇ and R₈ are methyl and R₃ and R₉ are propyl (—CH₂—)₃; and T, U, V, X, Y, and Z are O.

In yet another aspect of the present invention, a cyclic silane is presented having the formula: 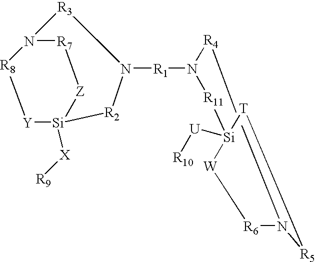
wherein R₁R₂, R₃, R₄, R₅, R₆, R₇, R₈, R₉, R₁₀ and R₁₁ are alkyl, substituted alkyl, aryl, or alkoxy and T, U, W, X, Y, and Z are O, S, NHR₁₂, wherein R₁₂ is H, alkyl, substituted alkyl, or aryl.

Preferably, in accordance with this aspect of the present invention, T, U, W, X, Y and Z are O; and R₁, R₃, R₄, R₅, R₇, R₈ are ethyl, R₂ and R₁₁ are propyl (—CH₂—)₃, and R₉ and R₁₀ are methyl.

In accordance with another aspect of the present invention, a cyclic silane is presented having the formula: 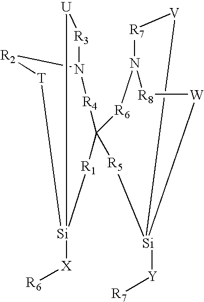
wherein R₁, R₂, R₃, R₄, R₅, R₆, R₇, and R₈ are alkyl, substituted alkyl, aryl, or alkoxy and T, W, X, and Y are O, S, NHR₁₁, wherein R₁₁ is H, alkyl, substituted alkyl, or aryl. Preferably, according to the present invention, R₆ and R₇ are methyl, R₁ and R₅ are propyl (—CH₂—)₃, R₂, R₃, R₄, and R₈ are ethyl and T, W, X, and Y are O.

In accordance with another aspect of the present invention, a cyclic silane is presented having the formula: 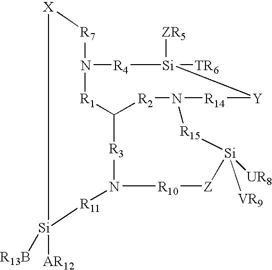
wherein R₁, R₂, R₃, R₄, R₅, R₆, R₇, R₈, R₉, R₁₀, R₁₁, R₁₂, R₁₃, R₁₄, and R₁₅ are alkyl, substituted alkyl, aryl, or alkoxy and A, B, T, U, V, X, Y and Z are O, S, NHR₁₆, wherein R₁₆ is H, alkyl, substituted alkyl, or aryl.

Preferably, according to the present invention, R₄, R₁₁, and R₁₅ are propyl (—CH₂—)₃, R₁, R₂, R₃, R₅, R₆, R₇, R₈, R₉, R₁₀, R₁₂, R₁₃ R₁₄ are ethyl, and A, B, T, U, V, X, Y and Z are O.

In accordance with another aspect of the present invention, a cyclic silane is presented having the formula is also presented: 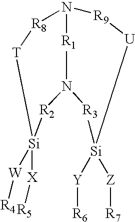
wherein R₁, R₂, R₃, R₅, R₆, R₇, R₈, and R₉, are alkyl, substituted alkyl, aryl, or alkoxy and T, U, W, X, Y and Z are O, S, NHR₁₀, wherein R₁₀ is H, alkyl, substituted alkyl, or aryl.

Preferably, according to the present invention, R1, R2 and R3 are propyl (—CH₂—)₃, R₄, R₅, R_{6,}R₇, R₈, and R₉ are ethyl and T, U, W, X, Y, and Z are O.

A similarly structured cyclic silane is shown below: 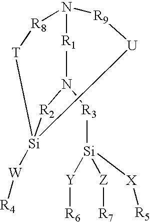
wherein R₁, R₂, R₃, R₄, R₅, R₆, R₇, R₈, and R₉, are alkyl, substituted alkyl, aryl, or alkoxy and T, U, W, X, Y and Z are O, S, NHR₁₀, wherein R₁₀ is H, alkyl, substituted alkyl, or aryl. Preferably, according to the present invention, R1, R2 and R3 are propyl (—CH₂—)₃, R4, R5, R6, R7, R8, and R9 are ethyl and T, U, W, X, Y, and Z are O.

In yet another aspect of the present invention, a cyclic silane with the formula below is shown: 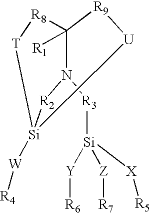
wherein R₁, R₂, R₃, R₄, R₅, R₆, R₇, R₈, and R₉, are alkyl, substituted alkyl, aryl, or alkoxy and T, U, W, X, Y and Z are O, S, NHR₁₀, wherein R₁₀ is H, alkyl, substituted alkyl, or aryl. Preferably, according to the present invention, R₂ and R₃ are propyl (—CH₂—)₃, R₁, R₈ and R₉ is methyl, R₄, R₅, R₆, R₇ are ethyl and T, U, W, X, Y, and Z are O.

In still another aspect of the present invention, a cyclic silane having the following formula is shown: 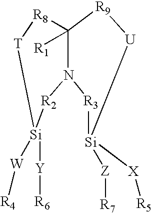
wherein R₁, R₂, R₃, R₄, R₅, R₆, R₇, R₈, and R₉, are alkyl, substituted alkyl, aryl, or alkoxy and T, U, W, X, Y and Z are O, S, NHR₁₀, wherein R₁₀ is H, alkyl, substituted alkyl, or aryl. Preferably, according to the present invention, R₂ and R₃ are propyl (—CH₂—)₃, R₁, R₈ and R₉ is methyl, R₄, R₅, R₆, R₇ are ethyl and T, U, W, X, Y, and Z are O.

In accordance with another aspect of the present invention, the following cyclic silane is disclosed: 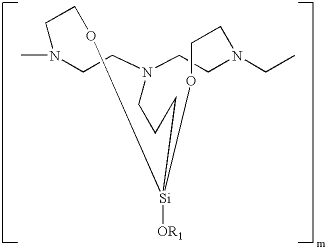
wherein R₁ is alkyl and repeating polymeric units are designated by n which is 5 to 10,000. R₁ is an alkane, substituted alkane, or alkoxy.

In another embodiment of the present invention, a cyclic silane is presented having the formula 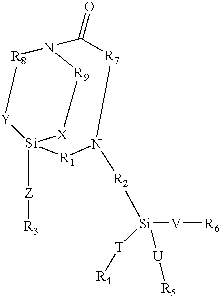
wherein R₁, R₂, R₃, R₄, R₅, R₆, R₇, R₈, and R₉, are alkyl, substituted alkyl, aryl, or alkoxy and T, U, V, X, Y and Z are O, S, NHR₁₀, wherein R₁₀ is H, alkyl, substituted alkyl, or aryl. Preferably, according to the present invention R₃, R₄, R₅ and R₆ are methyl, R₁ and R₂ are propyl (—CH₂)₃, R₇, R₈, and R₉ are ethyl and T, U, V, X, Y and Z are O.

In accordance with yet another aspect of the present invention, a cyclic silane having the formula set forth below is presented: 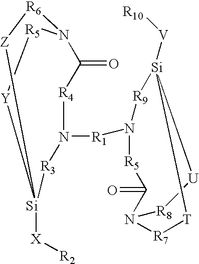
wherein R₁, R₂, R₃, , R₅, R₆, R₇, R₈, R₉, and R₁₀ are alkyl, substituted alkyl, aryl, or alkoxy and T, U, V, X, Y and Z are O, S, NHR₁₁, wherein R₁₁ is H, alkyl, substituted alkyl, or aryl. Preferably, according to the present invention, R₁, R₄, R₅, R₆, R₇ and R₈ are ethyl, R₃ and R₉ are propyl, R₂ and R₁₀ are methyl, and T, U, V, X, Y, and Z are O.

In accordance with yet another aspect of the present invention, a polymeric cyclic silane is presented have the following formula: 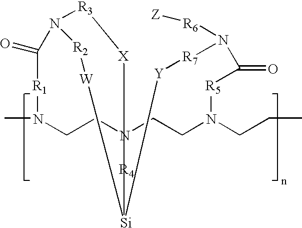
wherein R₁, R₂, R₃, R₅, R₆, and R₇ are alkyl, substituted alkyl, aryl, or alkoxy and W, X, Y and Z are O, OH, S, NHR₈, wherein R₈ is H, alkyl, substituted alkyl, or aryl. In the above, polymeric cyclic structure n represents the repeating units of the polymer. n is an integer is from 5 to 10,000. Preferably, according to the present invention, R4 is propyl, R1, R2, R3, R5, R6, and R7 are ethyl and W, X, Y and Z are O or OH.

In yet another aspect of the present invention, a cyclic silane having the following formula is presented: 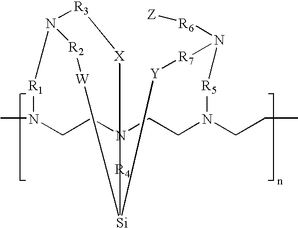
wherein R₁, R₂, R₃, R₄, R₅, R₆, and R₇ are alkyl, substituted alkyl, aryl, or alkoxy and W, X, Y and Z are O, OH, S, NHR₈, wherein R₈ is H, alkyl, substituted alkyl, or aryl and n is an integer between 5 and 10,000. Preferably, according to the present invention, R4 is propyl, R1, R2, R3, R5, R6, and R7 are ethyl and W, X, Y and Z are O or OH.

In still another embodiment of the present invention, the following cyclic, polymeric silane structure is presented. 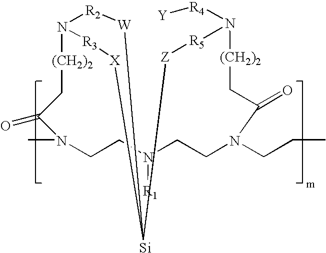
wherein R₁, R₂, R₃, R₄ and R₅ are alkyl, substituted alkyl, aryl, or alkoxy and W, X, Y and Z are O, OH, S, NHR₆, wherein R₆ is H, alkyl, substituted alkyl, or aryl and m is an integer between 5 and 10,000. Preferably, according to the present invention, R1 is propyl (—CH₂—)₃, R₁, R₂, R₃, and R₅ are ethyl and W, X, Y and Z are O or OH.

### EXAMPLES

In accordance with one aspect of the present invention, it has been discovered that [symbol] hydroxyethyl)-N-(3-triethoxysilylpropyl)amine (“Bis”) and N-(2- [symbol] yl)-N,N-bis(3-trimethoxysilylpropyl)amine (“Bis-B”) may, under some [symbol] ices, have cyclic structures. The linear structures of Bis and Bis-B are [symbol] below: 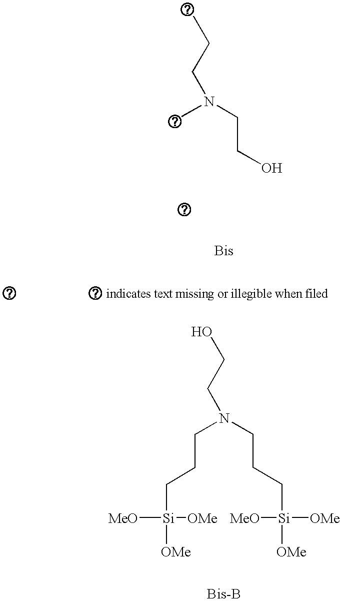 [symbol] he synthesis and use of silanes in the fabrication of arrays, including high [symbol] ucleic acid arrays, is described for example in U.S. Pat. Nos. 6,262,216, [symbol] 6,486,287 and 6,429,275, each of which are incorporated herein by reference. [symbol] Bis-B are typically synthesized by treatment of the corresponding aminosilane [symbol] ylene oxide. (See U.S. Pat. No. 6,486,287). These reagents are supplied as 65% [symbol] in either ethanol (Bis) or methanol (Bis-B) to prevent intermolecular [symbol] ization, since the hydroxyl functionality could in principle displace a silyl alkoxy [symbol] Analysis of the Bis and Bis-B reagents reveals that these compounds may have [symbol] structures under certain circumstances as described below. [symbol] pectra [symbol] Interpretation of the NMR spectra of Bis and Bis-B are complicated somewhat by [symbol] ence of the alcohol solvent in which they are kept and also by varying amounts of [symbol] hoxyethanol (Bis) or methoxyethanol (Bis-B). The latter components [symbol] ably result from the reaction of either ethanol or methanol with ethylene oxide.

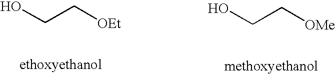

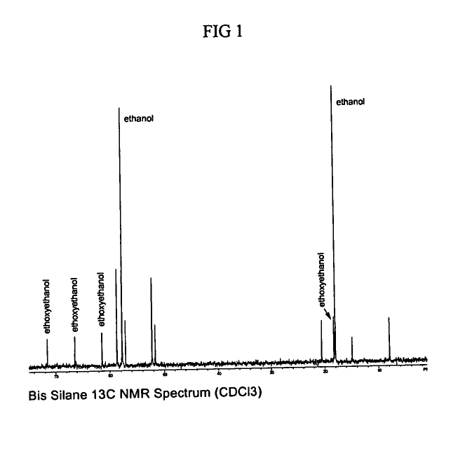

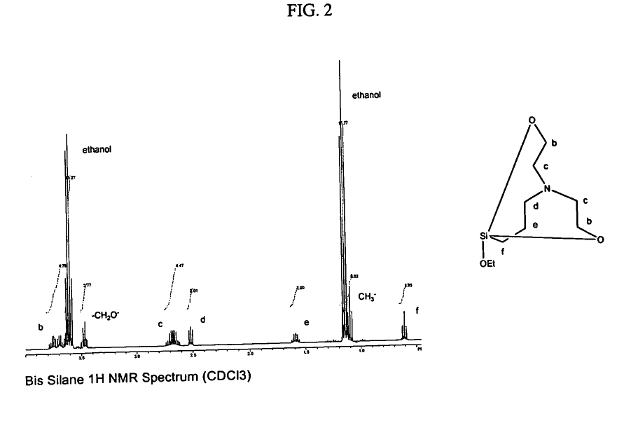

The ¹³C NMR spectrum of Bis (FIG. 1) reveals two resonances that can be attributed to ethanol, and four others that can be attributed to 2-ethoxyethanol. The remaining seven resonances are consistent with the seven unique carbon atoms of Bis (note the structural plane of symmetry). The corresponding ¹H NMR spectrum (FIG. 2) shows the expected five CH₂ groups, two of which integrate to four protons due to the symmetry element. Interestingly, the methyl region near 1.1 ppm seems to indicate a mono-alkoxy silane as opposed to a tri-alkoxy silane. This could arise if both 2-hydroxyethyl groups displaced ethoxy groups in an intramolecular manner. If only a single ethoxy group was displaced, the structure would lose symmetry and two additional ¹³C NMR resonances would be expected, as well a more complex 1H NMR pattern.

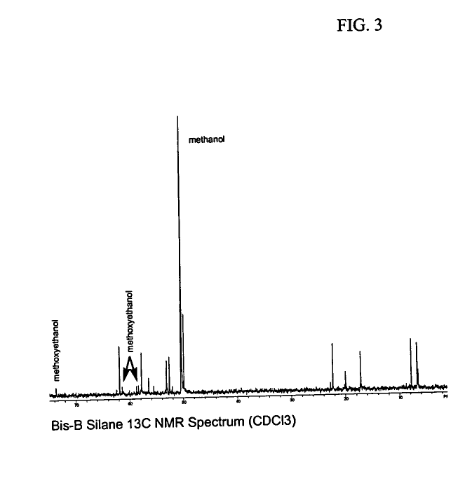

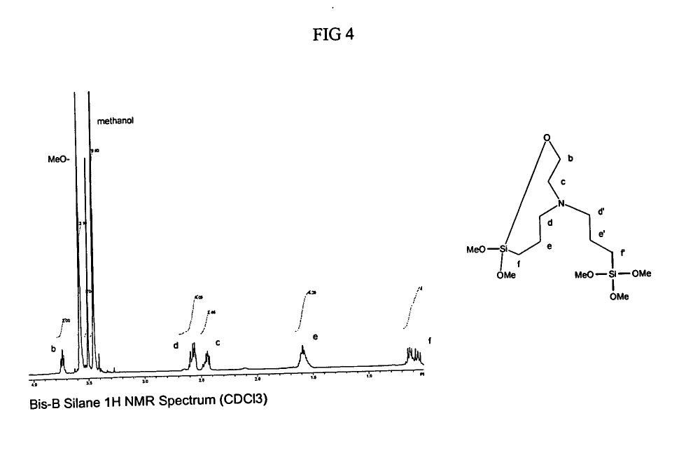

The ¹³C NMR spectrum of Bis-B (FIG. 3) reveals one resonance for methanol, and three small resonances that can be attributed to methoxyethanol. Apart from these signals, the spectrum shows ten other resonances. This number of unique signals would be consistent with a cyclic structure due to intramolecular displacement of a methoxy group by the 2-hydroxyethanol moiety. In contrast, the symmetrical, non-cyclized form of Bis-B would be expected to show a total of only six resonances. The ¹H NMR spectrum of Bis-B (FIG. 4) is not well defined, in contrast to the corresponding spectrum of Bis. Whereas the doubly-cyclized form of Bis retains symmetry, the cyclized form of Bis-B does not, and therefore complex overlapping signals would be expected. Although the ¹H NMR spectrum of Bis-B reveals three signals near 3.5 ppm, the integration is not in perfect agreement with a cyclized structure (expect methanol+9H+6H).

GC/MS

Gas chromatography and mass spectrometry were also carried out with Bis and Bis-B. When considered together with the solution-phase NMR data, the results are informative and further suggest that both Bis and Bis-B exist in a cyclic form.

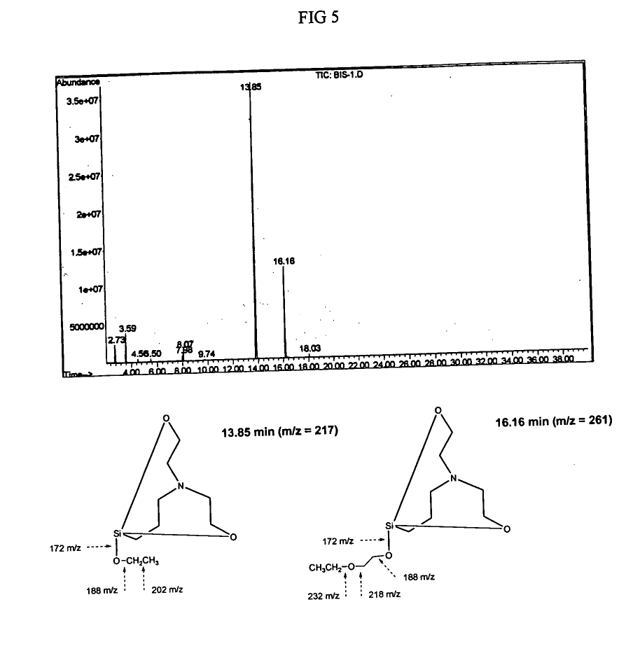

The GC/MS ion chromatogram for Bis (FIG. 5) shows two primary peaks with retention times of 13.85 and 16.16 minutes, at about a 3:1 height ratio, respectively. The MS of the larger peak (13.85 minutes) shows a parent ion with a mass of 217 m/z and fragments at 202, 188 and 172 m/z. This mass and fragmentation pattern is consistent with a bicyclic silane structure. The fragments correspond to loss of CH₃, CH₃CH₂, and CH₃CH₂O. The MS of the smaller peak (16.16 minutes) shows a parent ion with a mass of 261 m/z and fragments at 232, 218, 202, 188 and 172 m/z. This mass and fragmentation pattern is consistent with a bicyclic silane structure that also possesses a 2-ethoxyethanol group (substituted for ethanol). The fragments correspond to loss of CH₃CH₂, CH₃CH₂O, CH₃CH₂OCH₂CH₂ and CH₃CH₂OCH₂CH₂O. The two early-eluting peaks (2.73 and 3.59 minutes) correspond to ethoxyethanol and the dichloromethane diluent, respectively.

It should be noted that alternative interpretations of the mass spectra are possible. In addition, the fragmentation of the apparent minor component of the Bis silane ion chromatogram is explained equally well by “double” ethylene oxide addition during chemical synthesis. However, observations of changes in the ion chromatogram of Bis-B upon addition of 2-methoxyethanol (see below), and the presence of substantial levels of the corresponding 2-ethoxyethanol in the Bis silane preparation, suggest that the minor component is instead the 2-ethoxyethanol substituted silane.

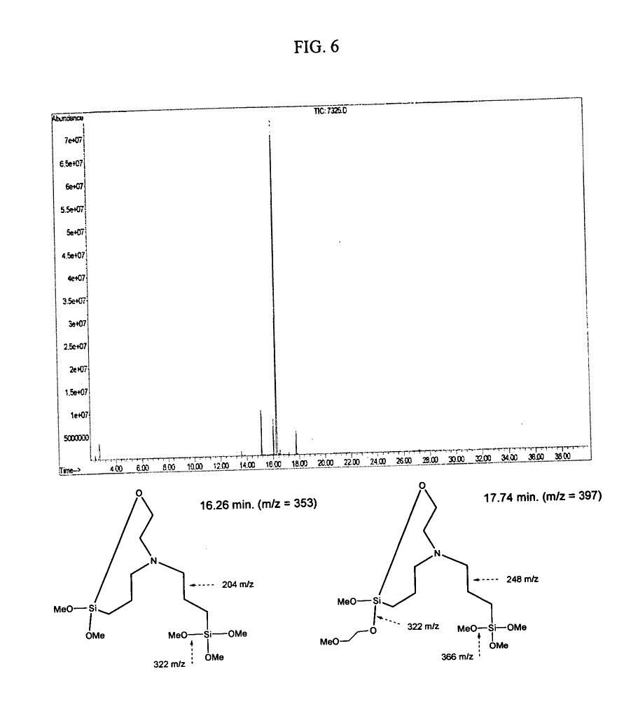

The GC/MS ion chromatogram for Bis-B (FIG. 6) is somewhat more complicated than the one for Bis, showing 2-3 unidentified peaks. However, as with Bis, the ion chromatogram shows two primary peaks with retention times of 16.26 and 17.74 minutes whose intensities range between 10:1 and 3:1 depending on the particular lot. The MS of the larger peak (16.26 minutes) shows a parent ion with a mass of 353 m/z and fragments at 322 and 204 m/z. This mass and fragmentation pattern is consistent with a cyclic silane structure. The fragments correspond to loss of CH₃O and (CH₃O)₃SiCH₂CH₂. The MS of the smaller peak (17.74 minutes) shows a parent ion with a mass of 397 m/z and fragments at 366, 322, 248 and 204 m/z. This mass and fragmentation pattern is consistent with a cyclic silane structure that also possesses a 2-methoxyethanol group (substituted for methanol). The fragments correspond to loss of CH₃O, CH₃OCH₂CH₂O, (CH₃O)₃SiCH₂CH₂ and possibly CH₃OCH₂CH₂O(CH₃O)₂SiCH₂CH₂. The two early-eluting peaks (<2 minutes) correspond to methoxyethanol and the dichloromethane diluent.

As with Bis silane, it should be noted that alternative interpretations of the mass spectra are possible. Also as indicated above, addition of 2-methoxyethanol to the Bis-B silane resulted in an increase in the relative height of the peak at 17.74 minutes, demonstrating that 2-methoxyethanol can readily displace silane methoxy groups and that this 397 m/z peak does not result from double ethylene oxide addition (the m/z would also be 397 if Bis-B reacted with a second unit of ethylene oxide).

Three-Dimensional Structure of Bis and Bis-B

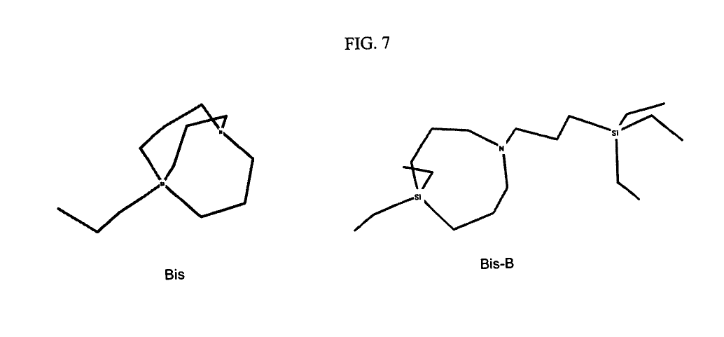

The proposed three-dimensional structures of Bis and Bis-B are depicted in FIG. 7, after MOPAC energy minimization. These structures are consistent with the analytical data presented earlier.

1. A cyclic silane having the formula 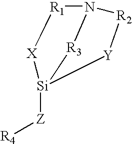
wherein R₁, R₂ R₃ and R₄ are independently alkyl, functionalized alkyl, aryl or alkoxy and X, Y and Z are independently a bond, O, S, NR₅, wherein R₅ is H, alkyl, substituted alkyl, or aryl.

2. A cyclic silane according to claim 1 wherein X , Y and Z are O.

3. A cyclic silane according to claim 2 wherein R₁, R₂, R₃ and R₄ are independently C₁ to C₁₀ alkyl.

4. A cyclic silane according to claim 3 wherein R₁, R₂ and R₄ are ethyl.

5. A cyclic silane according to claim 3 wherein R₁ and R₂ are ethyl and R₄ is methyl.

6. A cyclic silane according to claim 4 wherein R₃ is propyl.

7. A cyclic silane according to claim 1 wherein R₁ and R₂ are alkoxy.

8. A cyclic silane according to claim 1 wherein R₁ and R₂ are (CH₂CH₂O)ₙ wherein n is 1-4 and X and Y are bonds and Z is O.

9. A cyclic silane having the formula

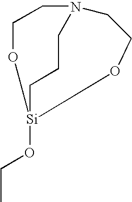

10. A cyclic silane having the formula 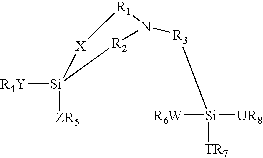
wherein R₁, R₂, R₃, R₄, R₅, R₆, R₇ and R₈ are independently alkyl, functionalized alkyl, aryl or alkoxy and T, R, U, X, Y, Z are independently a bond, O, S, NR₉, wherein R₉ is H, alkyl, substituted alkyl, or aryl.

11. A cyclic silane according to claim 10 wherein T, R, U, X, Y, Z are O.

12. A cyclic silane according to claim 11 wherein R₄, R₅, R₆, R₇, and R₈ are ethyl.

13. A cyclic silane according to claim 11 wherein wherein R₁, R₂, R₃, R₄, R₅, R_{6,} R₇ and R₈ are, independently, C₁ to C₁₀ alkyl.

14. A cyclic silane according to claim 13 wherein R₄, R₅, R₆, R₇ and R₈ are methyl.

15. A cyclic silane according to claim 14 wherein R₁ is ethyl, R₂ is propyl and R₃ is propyl.

16. A cyclic silane according to claim 10 wherein R₁ is alkoxy.

17. A cyclic silane according to claim 16 wherein R₁ is (CH₂CH₂O)ₙ wherein n is 1-4 and X is a bond.

18. A cyclic silane having the formula

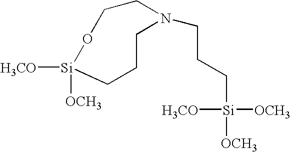

19. A composition of matter comprising a substantially pure cyclic silane according to any of claims 1-18, above.

20. A cyclic silane having the fomula 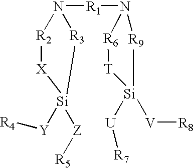
wherein R₁, R₂, R₃, R₄, R₅, R₆, R₇, R₈, and R₉ are alkyl, substituted alkyl, aryl, or alkoxy; and T, U, V, X, Y, and Z are O, S, NHR₁₀, wherein R₁₀ is H, alkyl, substituted alkyl, or aryl.

21. A cyclic silane according to claim 20 wherein R₁, R₂, and R₆ are ethyl, R₄, R₅, R₇ and R₈ are methyl and R₃ and R₉ are propyl (—CH₂—)₃; and T, U, V, X, Y, and Z are O.

22. A cyclic silane having the formula: 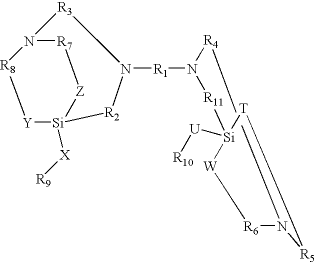
wherein R₁, R₂, R₃, R₄, R₅, R₆, R₇, R₈, R₉, R₁₀ and R₁₁ are alkyl, substituted alkyl, aryl, or alkoxy and T, U, W, X, Y, and Z are O, S, NHR₁₂, wherein R₁₂ is H, alkyl, substituted alkyl, or aryl.

23. A cyclic silane according to claim 22 wherein T, U, W, X, Y and Z are O; and R₁, R₃, R₄, R₅, R₆, R₇, R₈ are ethyl, R₂ and R₁₁ are propyl (—CH₂—)₃,and R₉ and R₁₀ are methyl.

24. A cyclic silane having the formula: 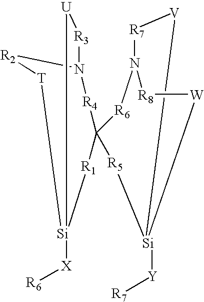
wherein R₁, R₂, R₃, R₄, R₅, R₆, R₇, and R₈ are alkyl, substituted alkyl, aryl, or alkoxy and T, W, X, and Y are O, S, NHR₁₁, wherein R₁₁ is H, alkyl, substituted alkyl, or aryl.

25. A cyclic silane according to claim 24 wherein R₆ and R₇ are methyl, R₁ and R₅ are propyl (—CH₂—)₃, R₂, R₃, R₄, and R₈ are ethyl and T, W, X, and Y are O.

26. A cyclic silane having the formula: 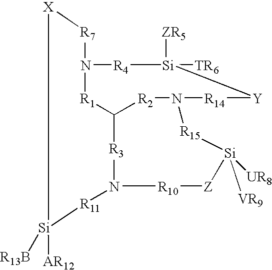
wherein R₁, R₂, R₃, R₄, R₅, R₆, R₇, R₈, R₉, R₁₀ , R₁₁ R₁₂, R₁₃, R₁₄, and R₁₅ are alkyl, substituted alkyl, aryl, or alkoxy and A, B, T, U, V, X, Y and Z are O, S, NHR₁₆, wherein R₁₆ is H, alkyl, substituted alkyl, or aryl.

27. A cyclic silane according to claim 26 wherein R₄, R₁₁, and R₁₅ are propyl (—CH₂—)₃, R₁, R₂, R₃, R₅, R₆, R₇, R₈, R₉, R₁₀, R₁₂, R₁₃ R₁₄ are ethyl, and A, B, T, U, V, X, Y and Z are O.

28. A cyclic silane having the formula 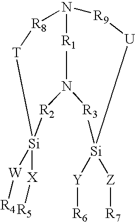
wherein R₁, R₂, R₃, R₅, R₆, R₇, R₈, and R₉, are alkyl, substituted alkyl, aryl, or alkoxy and T, U, W, X, Y and Z are O, S, NHR₁₀, wherein R₁₀ is H, alkyl, substituted alkyl, or aryl.

29. A cyclic silane according to claim 28 wherein R1, R2 and R3 are propyl (—CH₂—)₃, R₄, R₅, R₆, R₇, R₈, and R₉ are ethyl and T, U, W, X, Y, and Z are O.

30. A cyclic silane having the formula 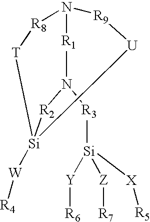
wherein R₁, R₂, R₃, R₄, R₅, R₆, R₇, R₈, and R₉, are alkyl, substituted alkyl, aryl, or alkoxy and T, U, W, X, Y and Z are O, S, NHR₁₀, wherein R₁₀ is H, alkyl, substituted alkyl, or aryl.

31. A cyclic silane according to claim 30 wherein R1 , R2 and R3 are propyl (—CH₂—)₃, R4, R5, R6, R7, R8, and R9 are ethyl and T, U, W, X, Y, and Z are O.

32. A cyclic silane having the formula 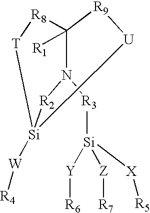
wherein R₁, R₂, R₃, R₅, R₆, R₇, R₈, and R₉, are alkyl, substituted alkyl, aryl, or alkoxy and T, U, W, X, Y and Z are O, S, NHR₁₀, wherein R₁₀ is H, alkyl, substituted alkyl, or aryl.

33. A cyclic silane according to claim 32 wherein R₂ and R₃ are propyl (—CH₂—)₃, R₁, R₈ and R₉ is methyl, R₄, R₅, R₆, R₇ are ethyl and T, U, W, X, Y, and Z are O.

34. A cyclic silane having the formula 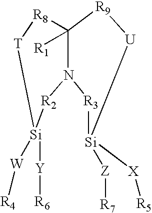
wherein R₁, R₂, R₃, R₄, R₅, R₆, R₇, R₈, and R₉, are alkyl, substituted alkyl, aryl, or alkoxy and T, U, W, X, Y and Z are O, S, NHR₁₀, wherein R₁₀ is H, alkyl, substituted alkyl, or aryl.

35. A cyclic silane according to claim 34 wherein R₂ and R₃ are propyl (—CH₂—)₃, R₁, R₈ and R₉ are methyl, R₄, R₅, R₆, R₇ are ethyl and T, U, W, X, Y, and Z are O.

36. A cyclic silane having the formula: 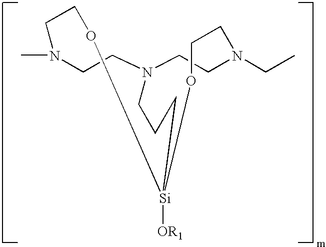
wherein R₁ is alkyl, substituted alkyl, aryl, or alkoxy and repeating and m is an interger from 5 to 10,000.

37. A cyclic silane according to claim 36 wherein R₁ is methyl or ethyl.

38. A cyclic silane having the formula 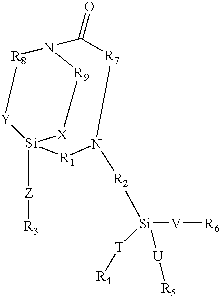
wherein R₁, R₂, R₃, R₄, R₅, R₆, R₇, R₈, and R₉, are alkyl, substituted alkyl, aryl, or alkoxy and T, U, V, X, Y and Z are O, S, NHR₁₀, wherein R₁₀ is H, alkyl, substituted alkyl, or aryl.

39. A cyclic silane according to claim 38 wherein R₃, R₄, R₅ and R₆ are methyl, R₁ and R₂ are propyl (—CH₂)₃, R₇, R₈, and R₉ are ethyl and T, U, V, X, Y and Z are O.

40. A cyclic silane having the formula 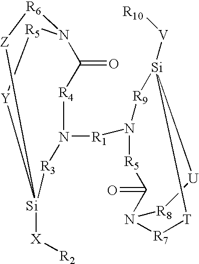
wherein R₁, R₂, R₃, R₄, R₅, R₆, R₇, R₈, R₉, and R₁₀ are alkyl, substituted alkyl, aryl, or alkoxy and T, U, V, X, Y and Z are O, S, NHR₁₁, wherein R₁₁ is H, alkyl, substituted alkyl, or aryl.

41. A cyclic silane according to claim 40 wherein R₁, R₄, R₅, R₆, R₇ and R₈ are ethyl, R₃ and R₉ are propyl, R₂ and R₁₀ are methyl, and T, U, V, X, Y, and Z are O.

42. A cyclic silane having the formula 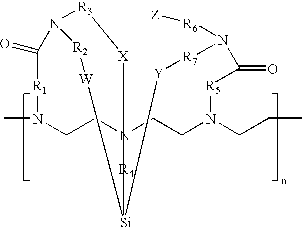
wherein R₁, R₂, R₃, R₄, R₅, R₆, and R₇ are alkyl, substituted alkyl, aryl, or alkoxy and W, X, Y and Z are O, OH, S, NHR₈, wherein R₈ is H, alkyl, substituted alkyl, or aryl and n is an integer from 5 to 10,000.

43. A cyclic silane according to claim 42 wherein R4 is propyl, R1, R2, R3, R5, R6, and R7 are ethyl and W, X, Y and Z are O or OH.

44. A cyclic silane having the formula 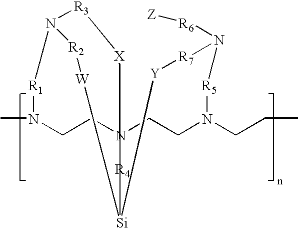
wherein R₁, R₂, R₃, R₄, R₅, R₆, and R₇ are alkyl, substituted alkyl, aryl, or alkoxy and W, X, Y and Z are O, OH, S, NHR₈, wherein R₈ is H, alkyl, substituted alkyl, or aryl and n is an integer from 5 to 10,000.

45. A cyclic silane according to claim 44 wherein R4 is propyl, R1, R2, R3, R5, R6, and R7 are ethyl and W, X, Y and Z are O or OH.

46. A cyclic silane having the formula 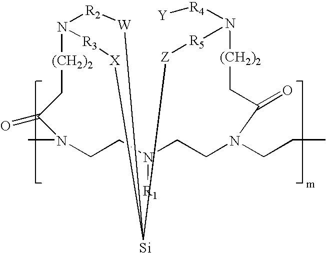
wherein R₁, R₂, R₃, R₄ and R₅ are alkyl, substituted alkyl, aryl, or alkoxy and W, X, Y Z are O, OH, S, NHR₆, wherein R₆ is H, alkyl, substituted alkyl, or aryl and m is an integer from 5 to 10,000.

47. A cyclic silane according to claim 46 wherein R1 is propyl (—CH₂—)₃, R₁, R₂, R₃, and R₅ are ethyl and W, X, Y and Z are O or OH.

48. A composition of matter comprising a substantially pure cyclic silane according to any of claims 20-47, above.
